(19) United States
(12) Patent Application Publication
(10) Pub. No.: US 2025/0201488 A1
(43) Pub. Date: Jun. 19, 2025

(54) SOLID ELECTROLYTIC CAPACITOR ELEMENT AND SOLID ELECTROLYTIC CAPACITOR

(71) Applicant: Panasonic Intellectual Property Management Co., Ltd., Osaka (JP)

(72) Inventors: Yuta TOMIMATSU, SHIGA KEN (JP); Masamichi INOUE, OSAKA FU (JP)

(21) Appl. No.: 19/072,703

(22) Filed: Mar. 6, 2025

Related U.S. Application Data
(63) Continuation of application No. PCT/JP2023/026234, filed on Jul. 18, 2023.

(30) Foreign Application Priority Data
Sep. 30, 2022 (JP) 2022-157325

(51) Int. Cl. H01G 9/025; H01G 9/10; H01G 9/15; H01G 9/26

(52) U.S. Cl. CPC H01G 9/025; H01G 9/15; H01G 9/10; H01G 9/26

(57) ABSTRACT

A solid electrolytic capacitor element included in a solid electrolytic capacitor includes an anode body, a dielectric layer formed at a surface of the anode body, and a cathode section covering at least part of the dielectric layer. The cathode section includes a solid electrolyte layer covering at least part of the dielectric layer, and includes a metal particle-containing layer in at least part of the cathode section. Metal particles contained in the metal particle-containing layer include first metal particles containing silver. The first metal particles each include a core particle containing silica, and a silver-containing coating layer covering the core particle.

### CROSS REFERENCE TO RELATED APPLICATION

The present application is a continuation application of International Application No. PCT/JP2023/026234, filed on Jul. 18, 2023 and claims priority with respect to the Japanese Patent Application No. 2022-157325 filed on Sep. 30, 2022. The entire contents of these prior applications are incorporated herein by reference.

### TECHNICAL FIELD

The present disclosure relates to a solid electrolytic capacitor element and a solid electrolytic capacitor.

### BACKGROUND

A solid electrolytic capacitor includes a solid electrolytic capacitor element, a package body sealing the solid electrolytic capacitor element, and external electrodes electrically connected to the solid electrolytic capacitor element. The solid electrolytic capacitor element includes an anode body, a dielectric layer formed at a surface of the anode body, and a cathode section covering at least part of the dielectric layer. The cathode section includes, for example, a solid electrolyte layer containing a conductive polymer and covering at least part of the dielectric layer, and a cathode-leading layer covering at least part of the solid electrolyte layer. The cathode-leading layer includes, for example, a carbon layer covering at least part of the solid electrolyte layer, and a metal particle-containing layer covering at least part of the carbon layer. The cathode-leading layer is electrically connected, via a cathode lead, to the external electrode on the cathode side.

In view of ensuring high conductivity, the metal particle-containing layer is often formed using a conductive paste containing silver particles and a resin binder. However, this involves drawbacks, such as cost increase due to the use of expensive silver particles.

One proposal suggests using copper particles instead of silver particles in the metal particle-containing layer. For example, Patent Literature 1 (JPH4-85915A) proposes a tantalum solid electrolytic capacitor including a sintered body made of fine powder of a valve metal, in which an oxide film layer, a manganese dioxide layer, and a conductive layer made of fine carbon powder are sequentially formed on the sintered body, and a conductive paste containing copper powder is further formed thereon.

### SUMMARY

A solid electrolytic capacitor is, in general, soldered onto a substrate through a reflow process during which it is exposed to high temperatures. Using copper particles instead of silver particles in the conductive paste used for the cathode section can reduce the cost, but in a solid electrolytic capacitor having a solid electrolyte layer containing a conductive polymer, the leakage current after exposure to high temperatures increases significantly.

A first aspect of the present disclosure relates to a solid electrolytic capacitor element, including
an anode body, a dielectric layer formed at a surface of the anode body, and a cathode section covering at least part of the dielectric layer, wherein
the cathode section includes a solid electrolyte layer covering at least part of the dielectric layer, and includes a metal particle-containing layer in at least part of the cathode section,
the solid electrolyte layer contains a conductive polymer,
metal particles contained in the metal particle-containing layer include first metal particles containing silver, and
the first metal particles each include a core particle containing silica, and a silver-containing coating layer covering the core particle.

A second aspect of the present disclosure relates to a solid electrolytic capacitor, including at least one solid electrolytic capacitor element described above, and a package body sealing the solid electrolytic capacitor element.

According to the present disclosure, it is possible to reduce the manufacturing cost of the solid electrolytic capacitor and reduce the leakage current after exposure to high temperatures.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWING

FIG. 1 A schematic sectional view of a solid electrolytic capacitor according to one embodiment of the present disclosure.

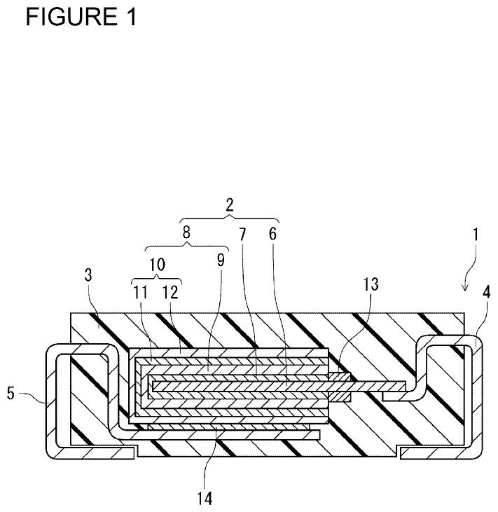

### DETAILED DESCRIPTION

Metal particles used in the metal particle-containing layer constituting part of the cathode section of the solid electrolytic capacitor are required to have high conductivity. The metal particle content in the metal particle-containing layer is relatively high (e.g., 80 mass % or more). It is expected therefore that, instead of silver particles, using copper particles or the like as metal particles having high conductivity can significantly reduce the cost.

A solid electrolytic capacitor is, in general, soldered onto a substrate through a reflow process during which it is exposed to high temperatures. Moreover, a solid electrolytic capacitor is used in a high temperature environment in some cases, depending on the application. In a solid electrolytic capacitor, when copper particles are used in the metal particle-containing layer, even though the initial leakage current is small, the leakage current may increase after the solid electrolytic capacitor is exposed to high temperatures. In addition, short-circuiting may occur due to a large leakage current, to increase the defect rate of the product (hereinafter sometimes referred to as the short-circuit defect rate).

The reason why the leakage current after exposure to high temperatures increases in a solid electrolytic capacitor having a metal particle-containing layer containing copper particles is presumably as follows. When the solid electrolytic capacitor is exposed to high temperatures, the copper particles, which are more easily ionized than silver particles, are ionized by the action of heat or the action of gas generated from the polymer film, and migrate from the metal particle-containing layer to the solid electrolyte layer. The copper ions are apt to interact with a constituent component (e.g., dopant) of the conductive polymer contained in the solid electrolyte layer, and as a result, the copper ions migrate into the solid electrolyte layer. The copper ions interact or react with the constituent component present in the surroundings (constituent component of the conductive polymer, etc.), or are reduced. And, a copper-containing component reaches the dielectric layer. When the solid electrolytic capacitor is exposed to high temperatures, an organic component such as a resin binder or its cured product contained in the cathode section expands, and a stress is generated in its inside. The stress is therefore transmitted to the dielectric layer, which is very thin, tending to cause a damage therein. When a copper component (e.g., copper ions, a component formed through interaction of copper ions with a constituent component of the conductive polymer etc., metal copper, a copper compound, and other conductive components containing copper) is present in the damaged spot of the dielectric layer, the anode body and the cathode section are electrically connected each other via the copper component, and a relatively large leakage current occurs. When the solid electrolytic capacitor is in the state of having absorbed moisture from the atmosphere during storage, a greater stress will be applied to the dielectric layer when exposed to high temperatures, increasing the possibility of causing a damage in the dielectric layer. Therefore, in this case, the leakage current is further increased. In a capacitor that does not include a solid electrolyte layer containing a conductive polymer, almost no interaction occurs between copper ions and the constituent component of the conductive polymer, and the migration itself of the copper ions toward the dielectric layer is suppressed.

### Technique (1)

In view of the above, a solid electrolytic capacitor element according to a first aspect of the present disclosure includes an anode body, a dielectric layer formed on a surface of the anode body, and a cathode section covering at least part of the dielectric layer. The cathode section includes a solid electrolyte layer covering at least part of the dielectric layer, and includes a metal particle-containing layer in at least part of the cathode section. The solid electrolyte layer contains a conductive polymer. Metal particles contained in the metal particle-containing layer include first metal particles containing silver. The first metal particles each include a core particle containing silica and a silver-containing coating layer covering the core particle.

In the solid electrolytic capacitor element according to the present disclosure, the first metal particles each include a core particle containing silica. This can reduce the silver content in the metal particle-containing layer. Therefore, the cost can be suppressed low. In addition, both silver and silica are hardly ionized and unlikely to interact with a constituent component of the conductive polymer. Therefore, the migration of the ions of the constituent component of the first metal particles to the solid electrolyte layer, as occurring in the case of copper particles, is unlikely to occur. Thus, the leakage current after the solid electrolytic capacitor is exposed to high temperatures can be reduced. Since the occurrence of a large leakage current is suppressed, the short-circuit defect rate can be reduced. In addition, in the present disclosure, even when the solid electrolytic capacitor is exposed to a high humidity environment (including a high temperature and high humidity environment), the leakage current can be suppressed small. In other words, excellent moisture resistance of the solid electrolytic capacitor can be achieved, and high reliability can be ensured. According to the present disclosure, it is also possible to ensure high moisture resistance comparable to that in the case of using the conventional silver paste layer containing silver particles.

With the first metal particles, in which the coating layer contains silver, it is easy to ensure high conductivity of the metal particle-containing layer. The first metal particles, in which the core particle is silica, has small specific gravity, as compared to particles formed entirely of metal. Therefore, with a paste for forming a metal particle-containing layer, the solid electrolyte layer can be covered with a small mass. By using such a paste, it is possible to form a metal particle-containing layer having high conductivity, while reducing the cost per unit volume. Therefore, the initial equivalent series resistance (ESR) of the solid electrolytic capacitor can also be suppressed low. In addition, since the coating layer of the first metal particles contains silver, as compared to using copper particles, the oxidation deterioration of the first metal particles is suppressed even when exposed to a high temperature environment or a high temperature and high humidity environment. Therefore, by using the first metal particles, as compared to using copper particles, the increase in ESR when exposed to high temperatures or a high temperature and high humidity environment can be suppressed. Therefore, high reliability of the solid electrolytic capacitor can be ensured.

### Technique (2)

In the above technique (1), the proportion of the first metal particles in the whole metal particles may be 10 mass % or more. A cost reduction effect can be obtained according to the proportion of the first metal particles. Furthermore, as compared to using copper particles, the effect of suppressing leakage current can be increased according to the proportion of the first metal.

### Technique (3)

In the above technique (1) or (2), an average of aspect ratios of the core particles may be 1 or more and 10 or less. When the aspect ratio of the core particle is in such a range, the contacts between the first metal particles can be relatively easily ensured, and the first metal particles are likely to be highly dispersed in the paste.

### Technique (4)

In any one of the above techniques (1) to (3), an average of proportions of the silver-containing coating layers in the first metal particles may be 0.1 mass % or more and 50 mass % or less. When the proportion of the silver-containing coating layer is in such a range, it is easy to balance between low cost and high conductivity.

### Technique (5)

In any one of the above techniques (1) to (4), the metal particles may include second metal particles containing silver. Here, each of the second metal particles is at least one selected from the group consisting of silver particles and silver alloy particles. When the metal particles include second metal particles containing silver, higher conductivity of the metal particle-containing layer can be ensured, and the ESR of the solid electrolytic capacitor can be suppressed low. In addition, the increase in ESR of the solid electrolytic capacitor can be suppressed even after exposure to a high temperature environment or a high temperature and high humidity environment, and high reliability can be ensured.

### Technique (6)

The present disclosure also encompasses a solid electrolytic capacitor including the solid electrolytic capacitor element according to any one of the above techniques (1) to (5), and a package body sealing the solid electrolytic capacitor element.

### Technique (7)

In the above technique (6), the solid electrolytic capacitor may include a plurality of the solid electrolytic capacitor elements stacked together.

In the present specification, the metal particle-containing layer containing first metal particles is sometimes referred to as a first metal particle-containing layer. The solid electrolytic capacitor element is sometimes simply referred to as a capacitor element.

The cathode section includes, for example, a solid electrolyte layer and a cathode-leading layer covering at least part of the solid electrolyte layer. When the cathode-leading layer and the cathode lead are connected to each other with a conductive adhesive, in the present specification, a conductive adhesive layer interposed between the cathode-leading layer and the cathode lead (hereinafter, sometimes referred to as a first conductive adhesive layer) is also encompassed in the cathode section. In a solid electrolytic capacitor including a plurality of capacitor elements, when the plurality of capacitor elements are fixed together with a conductive adhesive, in the present specification, a conductive adhesive layer fixing between adjacent capacitor elements (hereinafter, sometimes referred to as a second conductive adhesive layer) is also encompassed in the cathode section (specifically, the cathode section of one of the capacitor elements).

In any one of the above techniques (1) to (7), the cathode section may include the first metal particle-containing layer in at least part of at least one selected from the group consisting of the cathode-leading layer, the first conductive adhesive layer, and the second conductive adhesive layer. For example, the cathode-leading layer may include a first layer (sometimes referred to as a carbon layer) that contains a conductive carbon and covers at least part of the solid electrolyte layer, and the first metal particle-containing layer as a second layer that covers at least part of the first layer. The cathode section may include a metal particle-containing layer other than the first metal particle-containing layer (hereinafter, sometimes referred to as a second metal particle-containing layer or a third metal particle-containing layer). For example, the cathode-leading layer may include the carbon layer as the first layer and the second metal particle-containing layer as the second layer, and may include the first metal particle-containing layer as the first conductive adhesive layer interposed between the second metal particle-containing layer and the cathode lead. The solid electrolytic capacitor may include a stack formed by stacking a plurality of capacitor elements together each including a cathode-leading layer which includes the first layer and the second metal particle-containing layer as the second layer, via the first metal particle-containing layer as the second conductive adhesive layer. In such a stack, the cathode-leading layer of each capacitor element and the cathode lead may be connected to each other via the third or the first metal particle-containing layer as the first conductive adhesive layer.

The capacitor element and solid electrolytic capacitor of the present disclosure will be described in more detail below, including the above techniques (1) to (7). At least one selected from the components described below can be combined in any combination with at least one technique selected from the above techniques (1) to (5) for the solid electrolytic capacitor element of the present disclosure and the above techniques (6) and (7) for the solid electrolytic capacitor, as long as such combination is technically possible.

### [Solid Electrolytic Capacitor]

The solid electrolytic capacitor includes one or two or more capacitor elements.

### (Capacitor Element)

### (Anode Body)

The anode body included in the capacitor element may contain a valve metal, an alloy containing a valve metal, a compound containing a valve metal, and the like. The anode body may contain these materials singly or in combination of two or more. Examples of valve metal include aluminum, tantalum, niobium, and titanium.

The anode body has a porous part at least at its surface layer. Such a porous part provides the anode body, at least to the surface, with fine unevenness. The anode body with a porous part at its surface layer can be obtained by, for example, roughening the surface of a base material (sheet-like (e.g., foil-like or plate-like) base material, etc.) containing a valve metal. Roughening may be performed by etching or the like, for example. The anode body may be a molded body of valve metal-containing particles or its sintered body. The molded body and the sintered body may each, as a whole, constitute the porous part. The molded body and the sintered body may each have a sheet-like shape or may each have a rectangular parallelepiped shape, a cubic shape, or a shape similar thereto.

The anode body usually has an anode leading part and a cathode forming part. The porous part may be formed in the cathode forming part, or may be formed in the cathode forming part and the anode leading part. The cathode section is usually formed, via the dielectric layer, on the cathode forming part of the anode body. The anode leading part is used, for example, for electrical connection with an external electrode on the anode side.

### (Dielectric Layer)

The dielectric layer is formed, for example, so as to cover at least part of the surface of the anode body. The dielectric layer is an insulating layer that functions as a dielectric. The dielectric layer is formed by anodizing the valve metal on the surface of the anode body through chemical conversion treatment or the like. Since the dielectric layer is formed at the porous surface of the anode body, the surface of the dielectric layer has fine unevenness as mentioned above.

The dielectric layer contains an oxide of a valve metal. For example, when tantalum is used as the valve metal, the dielectric layer contains Ta₂O₅, and when aluminum is used as the valve metal, the dielectric layer contains Al₂O₃. The dielectric layer is not limited to these examples, and may be any layer that functions as a dielectric.

### (Cathode Section)

The cathode section is formed so as to cover at least part of the dielectric layer formed at a surface of the anode body. Each of the layers constituting the cathode section can be formed by a known method according to the layer configuration of the cathode section.

The cathode section includes, for example, a solid electrolyte layer covering at least part of the dielectric layer, and a cathode-leading layer covering at least part of the solid electrolyte layer. The cathode section may further include a first conductive adhesive layer interposed between the cathode-leading layer and the cathode lead. The cathode section may also include a second conductive adhesive layer for fixing between adjacent capacitor elements.

As described above, the first metal particle-containing layer may be included in at least part of at least one selected from the group consisting of the cathode-leading layer, the first conductive adhesive layer, and the second conductive adhesive layer. With regard to the influence on the leakage current, the cathode-leading layer, which is closer to the solid electrolyte layer, has a greater influence than the first conductive adhesive layer and the second conductive adhesive layer. In the present disclosure, when the cathode section includes a first metal particle-containing layer at least in the cathode-leading layer, the effect of reducing the leakage current after the solid electrolytic capacitor is exposed to high temperatures can be more remarkably obtained.

The components of the cathode section will be described below.

(Solid Electrolyte Layer) The solid electrolyte layer is formed on a surface of the anode body so as to cover the dielectric layer via the dielectric layer. The solid electrolyte layer may not necessarily cover all over the dielectric layer (the entire surface), but may be formed so as to cover at least part of the dielectric layer. The solid electrolyte layer constitutes at least part of the cathode section in the solid electrolytic capacitor.

The solid electrolyte layer includes a conductive polymer. The conductive polymer includes, for example, a conjugated polymer and a dopant. The solid electrolyte layer may further include an additive, as necessary.

The conjugated polymer may be a known conjugated polymer used in solid electrolytic capacitors, such as x-conjugated polymer. Examples of the x-conjugated polymer include polymers the backbone of which is polypyrrole, polythiophene, polyaniline, polyfuran, polyacetylene, polyphenylene, polyphenylene vinylene, polyacene, polythiophene vinylene, or the like. Preferred among them are polymers the backbone of which is polypyrrole, polythiophene, or polyaniline. It suffices when the above polymer contains at least one monomer unit constituting the backbone. The monomer unit also includes a monomer unit having a substituent. The above polymer includes a homopolymer and a copolymer of two or more monomers. For example, polythiophene includes poly(3,4-ethylenedioxythiophene) (PEDOT), and the like.

The solid electrolyte layer may contain these conjugated polymers singly, or in combination of two or more.

The weight average molecular weight (Mw) of the conjugated polymer is not particularly limited, and is, for example, 1,000 to 1,000,000.

In the present specification, the weight average molecular weight (Mw) is a value in terms of polystyrene as measured by gel permeation chromatography (GPC). In GPC, measurement is usually performed using a polystyrene gel column, and water/methanol (volume ratio 8/2) as a mobile phase.

The dopant may be, for example, at least one selected from the group consisting of an anion and a polyanion.

Examples of the anion include sulfate ions, nitrate ions, phosphate ions, borate ions, organic sulfonate ions, and carboxylate ions, but are not limited thereto. Examples of a dopant that generates sulfonate ions include benzenesulfonic acid, p-toluenesulfonic acid, and naphthalenesulfonic acid.

Examples of the polyanion include polymer anions. The solid electrolyte layer may contain, for example, a conjugated polymer containing a monomer unit corresponding to a thiophene compound and a polymer anion.

As the polymer anion, for example, a polymer having a plurality of anionic groups may be used. Examples of such a polymer include a polymer containing a monomer unit having an anionic group. Examples of the anionic group include a sulfonic acid group and a carboxyl group.

In the solid electrolyte layer, the anionic group of the dopant may be contained in a free form, the form of an anion, or in the form of a salt, or may be contained in a form bonded to or interacting with the conjugated polymer. In the present specification, all of these forms are sometimes simply referred to as “anionic group”, “sulfonic acid group”, or “carboxy group”. Examples of a polymer anion having a carboxy group include polyacrylic acid, polymethacrylic acid, and a copolymer formed using at least one of acrylic acid and methacrylic acid, but are not limited thereto.

Examples of a polymer anion having a sulfonic acid group include a polymer-type polysulfonic acid. Specific examples of the polymer-type polysulfonic acid include polyvinyl sulfonic acid, polystyrene sulfonic acid (including copolymers and substituted products having a substituent), polyallyl sulfonic acid, polyacrylic sulfonic acid, polymethacrylic sulfonic acid, poly(2-acrylamido-2-methylpropane sulfonic acid), polyisoprene sulfonic acid, polyester sulfonic acid (aromatic polyester sulfonic acid, etc.), and phenol sulfonic acid novolac resin, but are not limited thereto.

The amount of the dopant contained in the solid electrolyte layer is, for example, 10 parts by mass or more to 1000 parts by mass or less, 20 parts by mass or more to 500 parts by mass or less, or 50 parts by mass or more to 200 parts by mass or less, relative to 100 parts by mass of the conjugated polymer.

The solid electrolyte layer may further contain, as necessary, at least one selected from the group consisting of a known additive and a known conductive material other than conductive polymers. The conductive material may be, for example, at least one selected from the group consisting of a conductive inorganic material, such as manganese dioxide, and a TCNQ complex salt.

Note that a layer or something for enhancing adhesion may be interposed between the dielectric layer and the solid electrolyte layer.

The solid electrolyte layer may be a single layer or may be constituted of a plurality of layers. For example, the solid electrolyte layer may be configured to include a first solid electrolyte layer covering at least part of the dielectric layer and a second solid electrolyte layer covering at least part of the first solid electrolyte layer. The type, composition, content, etc. of the conjugated polymer, dopant, additive, and others contained in each layer may be different from layer to layer or the same.

The solid electrolyte layer is formed, for example, using a treatment liquid containing a precursor of conjugated polymer and a dopant, by polymerizing the precursor on the dielectric layer. The polymerization can be performed by at least either of chemical polymerization and electrolytic polymerization. Examples of the precursor of conjugated polymer include a monomer, an oligomer, and a prepolymer. The solid electrolyte layer may be formed by attaching a treatment liquid (e.g., a dispersion or a solution) containing a conductive polymer onto the dielectric layer, and then drying it. As a dispersion medium (or solvent), at least one selected from the group consisting of water and an organic solvent can be used. The treatment liquid may further contain other components (e.g., at least one selected from the group consisting of a dopant and an additive). For example, the solid electrolyte layer may be formed using a treatment liquid containing a conductive polymer (e.g., PEDOT), a dopant (e.g., a polyanion, such as polystyrene sulfonic acid), and, as necessary, an additive.

When using a treatment liquid containing a precursor of conjugated polymer, an oxidizing agent is used to polymerize the precursor. The oxidizing agent may be included in the treatment liquid as an additive. The oxidizing agent may be applied onto the anode body before or after bringing the treatment liquid into contact with the anode body provided with a dielectric layer. Examples of such an oxidizing agent include a compound capable of generating Fe³⁺ (ferric sulfate etc.), a persulfate (sodium persulfate, ammonium persulfate, etc.), and hydrogen peroxide. The oxidizing agent may be used singly or in combination of two or more.

The step of forming a solid electrolyte layer by immersion into a treatment liquid and polymerization (or drying) may be performed once, or may be repeated a plurality of times. The conditions, such as the composition and viscosity of the treatment liquid, may be the same each time, or at least one of the conditions may be changed.

### (Cathode-Leading Layer)

The cathode-leading layer includes at least a first layer being in contact with the solid electrolyte layer and covering at least part of the solid electrolyte layer, and may include the first layer and a second layer covering at least part of the first layer.

The first layer may be, for example, a layer containing conductive particles, a metal foil, and the like. The conductive particles include, for example, at least one selected from a conductive carbon and a metal powder. For example, the cathode-leading layer may be constituted of a layer containing a conductive carbon (carbon layer) as the first layer and a layer containing a metal powder or metal foil as the second layer. When a metal foil is used as the first layer, the metal foil may constitute the cathode-leading layer.

Examples of the conductive carbon include graphite (artificial graphite, natural graphite, etc.).

The layer containing a metal powder as the second layer can be formed by, for example, forming a layer of a composition containing a metal powder, on the surface of the first layer. Such a second layer may be, for example, a metal particle-containing layer which is formed using a paste containing a metal powder and a resin binder. As the resin binder, although a thermoplastic resin can be used, a thermosetting resin, such as an imide resin or an epoxy resin, is preferably used. For ensuring high conductivity of the second layer, silver-containing particles may be used as the metal powder. Examples of the silver-containing particles include first metal particles and second metal particles (specifically, silver particles and silver alloy particles). The second layer may contain these silver-containing particles singly, or in combination of two or more. For ensuring higher conductivity of the second layer, preferred as the silver-containing particles are silver particles and first metal particles. Silver particles can contain a small amount of impurities. The second layer containing the silver-containing particles may be a first metal particle-containing layer or a second metal particle-containing layer. The second layer, for example, may contain silver particles and silver alloy particles, may contain first metal particles, and may contain first metal particles and at least one of silver particles and silver alloy particles.

When a metal foil is used as the first layer, any kind of metal may be used. For the metal foil, a valve metal (aluminum, tantalum, niobium, etc.) or an alloy containing a valve metal is preferably used. The surface of the metal foil may be roughened as necessary. The surface of the metal foil may be provided with a chemical conversion film, and may be provided with a coating of a metal (dissimilar metal) different from the metal constituting the metal foil or of a non-metal. Examples of the dissimilar metal and the non-metal include metals, such as titanium, and non-metals, such as carbon (e.g., conductive carbon).

The aforementioned coating of a dissimilar metal or a non-metal (e.g., conductive carbon) may be used as the first layer, and the aforementioned metal foil may be used as the second layer.

When the cathode-leading layer includes a first metal particle-containing layer, the whole cathode-leading layer may be constituted of the first metal particle-containing layer, the first layer may be constituted of the first metal particle-containing layer, and the second layer may be constituted of the first metal particle-containing layer. For example, the cathode-leading layer may include a first layer (carbon layer) containing a conductive carbon and a second layer containing a first metal particle-containing layer covering at least part of the first layer.

The cathode-leading layer is formed by a known method according to its layer configuration. For example, when the cathode-leading layer includes a metal foil as the first layer or the second layer, the first layer or the second layer is formed by laminating a metal foil so as to cover at least part of the solid electrolyte layer or the first layer. The first layer containing conductive particles is formed by, for example, applying a conductive paste or liquid dispersion containing conductive particles and, as necessary, a resin binder (water-soluble resin, curable resin, etc.), onto a surface of the solid electrolyte layer. The second layer containing a metal powder is formed by, for example, applying a paste containing a metal powder and a resin binder onto a surface of the first layer. In the process of forming a cathode-leading layer, drying, heating, and other treatments may be performed as necessary.

In view of suppressing the increase of leakage current associated with the migration of copper ions in a high temperature environment, the cathode-leading layer (metal particle-containing layer, etc.) preferably contains neither copper particles nor copper alloy particles. From similar point of view, even when the cathode-leading layer contains at least one of copper particles and copper alloy particles, it is preferable that the total proportion of these particles is small. For example, the total proportion of the copper particles and the copper alloy particles in the whole metal particles contained in the metal particle-containing layer is, for example, less than 10 mass %, and more preferably 5 mass % or less, or 1 mass % or less. Even when the cathode-leading layer contains a metal foil, it is preferable that the metal foil contains no copper, or even when the metal foil contains copper, it is preferable that the copper content in the metal foil is low. The copper content in the metal foil is, for example, less than 10 mass %, and more preferably 5 mass % or less, or 1 mass % or less. Moreover, even when the metal-containing layer (the first and second layers, etc.) constituting the cathode-leading layer contains no copper or contains copper, the proportion of the copper in the whole metals contained in the metal-containing layer may be less than 10 mass %, 5 mass % or less, or 1 mass % or less.

### (First Conductive Adhesive Layer)

The solid electrolytic capacitor may include a cathode lead. In the solid electrolytic capacitor, the cathode lead is connected to the cathode-leading layer via a first conductive adhesive layer. When the solid electrolytic capacitor includes a plurality of capacitor elements, the cathode-leading layer of one or some of the capacitor elements and the cathode lead may be connected via a first conductive adhesive layer. With the first conductive adhesive layer, the cathode-leading layer of the capacitor element and the cathode lead are electrically connected to each other.

The first conductive adhesive layer may be formed using a known conductive adhesive. The known conductive adhesive include, for example, a paste containing conductive particles and a resin binder (curable resin, etc.). The first conductive adhesive layer formed using a known conductive adhesive may be a second metal particle-containing layer formed using a known silver-containing adhesive (e.g., silver-containing paste). Such a first conductive adhesive layer is formed by, for example, placing the above paste (including the silver-containing paste) so as to be sandwiched between the cathode-leading layer and the cathode lead. For example, the above paste may be applied or transferred onto part of the surface of the cathode-leading layer, and on the resultant applied film of the paste, one end portion of a cathode lead may be overlaid. In the process of forming a first conductive adhesive layer, drying, heating, and other treatments may be performed as necessary.

The first conductive adhesive layer may be a first metal particle-containing layer. In this case, the cathode section includes a first metal particle-containing layer interposed between the cathode-leading layer and the cathode lead.

### (Second Conductive Adhesive Layer)

When the solid electrolytic capacitor includes a plurality of capacitor elements, the plurality of capacitor elements may be fixed via a second conductive adhesive layer. For example, when the solid electrolytic capacitor includes a stack of a plurality of capacitor elements, the plurality of capacitor elements may be stacked together via a second conductive adhesive layer. The second conductive adhesive layer may be in contact with the cathode-leading layer of each capacitor element. With the second conductive adhesive layer, the plurality of capacitor elements are electrically connected to each other.

The second conductive adhesive layer may be formed using a known conductive adhesive. The known conductive adhesive includes, for example, a paste containing conductive particles and a resin binder (curable resin, etc.). The second conductive adhesive layer formed using a known conductive adhesive may be a third metal particle-containing layer formed using a known silver-containing adhesive (e.g., silver-containing paste). Such a second conductive adhesive layer is formed by, for example, placing the above paste (including the silver-containing paste) so as to be sandwiched between adjacent capacitor elements. For example, the above paste may be applied or transferred onto part of the surface of the cathode-leading layer of a capacitor element, and on the resultant applied film of the paste, another capacitor element may be overlaid. In the process of forming a second conductive adhesive layer, drying, heating, and other treatments may be performed as necessary.

The second conductive adhesive layer may be a first metal particle-containing layer. In this case, adjacent solid electrolytic capacitor elements are fixed via the first metal particle-containing layer.

The first metal particle-containing layer included in the cathode section will be more specifically described below.

### (First Metal Particle-Containing Layer)

The first metal particle-containing layer contains metal particles. The first metal particle-containing layer usually contains a resin binder or a cured product thereof.

The metal particles include first metal particles. The metal particles may further include second metal particles, and the second metal particles are specifically at least one kind selected from the group consisting of silver particles and silver alloy particles. The metal particles may further include third metal particles other than the first and second metal particles, in addition to the first metal particles or the first and second metal particles.

### (First Metal Particles)

The first metal particles each include a core particle and a silver-containing coating layer that covers the core particle. The core particle contains, for example, a silica. The silica may be crystalline or amorphous. The silica may be porous or non-porous. The core particles may be a fused silica.

The average of the aspect ratios of the core particles may be, for example, 1 or more and 100 or less, and may be 1 or more and 20 or less. In view of facilitating the formation of a relatively uniform silver-containing coating layer, the average of the aspect ratios is preferably 1 or more and 10 or less, and more preferably 1 or more and 5 or less. When the average of the aspect ratios is in such a range, the core particles are easily dispersed in the paste for forming a first metal particle-containing layer, and the first metal particles are likely to be arranged with high packability in the first metal particle-containing layer.

The shape of the core particles is not particularly limited, and may be spherical (including oval spherical), flaky, indefinite, or other shapes. For ease of formation of a relatively uniform silver-containing coating layer, dispersion in the paste, and high packing in the first metal particle-containing layer, the shape of the core particles is preferably spherical (including oval spherical, etc.).

In the present specification, “spherical particles” mean particles having a degree of sphericity of 0.6 or more and 1 or less. “Flaky particles” mean flat-shaped or thin flake-like particles.

The silver-containing coating layer may be constituted of silver or a silver alloy. In view of obtaining high conductivity, the silver-containing coating layer is preferably constituted of silver. In this case, the silver may contain a small amount of impurities.

The average of the proportions of the silver-containing coating layers in the first metal particles may be, for example, 0.1 mass % or more and 50 mass % or less, may be 1 mass % or more and 40 mass % or less, may be 5 mass % or more and 30 mass % or less, and may be 10 mass % or more and 30 mass % or less. When the proportion of the silver-containing coating layer is in such a range, most of the surface of the core particle is covered with the silver-containing coating layer, and the high conductivity of the first metal particles is likely to be ensured. In addition, the specific gravity of the first metal particles can be easily adjusted to be in an appropriate range, and the first metal particles are likely to be highly dispersed in the paste. It is therefore easy to ensure a good balance between the cost reduction effect and the high conductivity of the first metal particle-containing layer.

The first metal particles may include one kind of particles, or may include a combination of two or more kinds of particles differing in the composition of at least one of the core particle and the silver-containing coating layer.

The shape of the first metal particles is not particularly limited, and may be spherical (including oval spherical), flaky, indefinite, or other shapes. The first metal particles may include particles of one kind of shape, or may include a combination of particles of two or more kinds of shapes. The first metal particles preferably include at least spherical particles. In this case, the first metal particles are easily dispersed in the paste, and the first metal particles are likely to be arranged with high packability in the first metal particle-containing layer. Furthermore, in the first metal particle-containing layer, a lot of contact points between particles can be ensured. Thus, higher conductivity of the first metal particle-containing layer can be ensured. This leads to a tendency that the effect of suppressing the initial ESR low is enhanced. The first metal particles may include, for example, spherical particles and particles having a shape other than spherical.

In the present specification, the degree of sphericity of a particle can be estimated by obtaining a cross-sectional image including a plurality of particles (e.g., 10 or more particles) and analyzing the contours of the particles included in the image. The ratio of the diameter of a circle equal to the area inside the closed curve formed by a contour (hereinafter referred to as an “equivalent circle”) to the diameter of the smallest circle circumscribing the contour is calculated. The average value of this ratio for a plurality of particles is determined as a degree of sphericity of the particle. For example, in the case of including spherical particles and particles having a shape other than spherical, a plurality of particles are selected from the spherical particles, and the degree of sphericity is determined by the above procedure. The cross-sectional image may be an image obtained with a scanning electron microscope (SEM).

The above cross-sectional image can be obtained, for example, by the following procedure. First, the solid electrolytic capacitor is embedded in a curable resin, and the curable resin is cured. The cured product is wet-polished or dry-polished, to expose a cross section parallel to the thickness direction of the cathode section (a cross section in which the stacked state of respective layers in the cathode section can be confirmed). The exposed cross section is smoothed by ion milling, to obtain a sample for photographing. The cross-sectional image may be analyzed as necessary, using an image-analysis particle size distribution measurement software (e.g., MAC-View (Mountech Co., Ltd.)), to determine the contours of the particles.

The average of the aspect ratios of the core particles can also be determined from the aforementioned cross-sectional image. Specifically, in the cross-sectional image, a plurality of first metal particles (e.g., 10 or more) in which the core particles can be observed are randomly selected, and a maximum length “a” of each core particle is determined. For each core particle, a maximum length “b” in the direction perpendicular to the maximum length “a” is determined, and a ratio a/b is calculated as an aspect ratio of each core particle. With respect to a plurality of core particles, the ratios a/b are calculated and averaged. The average of the aspect ratios of the core particles can be thus determined.

The average particle diameter of the first metal particles may be, for example, 1 μm or more and 20 μm or less, and may be 1 μm or more and 10 μm or less. When the average particle diameter is in such a range, contacts between the first metal particles can be easily ensured, and higher conductivity of the first metal particle-containing layer is likely to be ensured.

In the present specification, the average particle diameter of the particles can be estimated by obtaining a cross-sectional image containing a plurality of particles (e.g., 10 or more particles) and analyzing the contours of the particles included in the image. The diameter of an equivalent circle equal to the area inside the closed curve formed by each contour is determined, to obtain an average of the determined values. The preparation of the sample for cross-sectional image and the analysis of the image are performed, for example, by the procedure similar to that for determining the degree of sphericity. The cross-sectional image may be analyzed as necessary, using the aforementioned software, to identify the contour of each particle, and the diameter of the equivalent circle or the smallest circumscribing circle having the same area as the area surrounded by the contour may be obtained.

The proportion of the first metal particles in the whole metal particles contained in the first metal particle-containing layer is, for example, 10 mass % or more, may be 30 mass % or more, and may be 50 mass % or more or 60 mass % or more. When the proportion of the first metal particles is increased, the average specific gravity of the metal particles is reduced. This is effective in reducing the cost per unit volume. From such a point of view, the proportion of the first metal particles in the whole metal particles contained in the first metal particle-containing layer may be 80 mass % or more, and may be more than 90 mass %. The proportion of the first metal particles in the whole metal particles contained in the first metal particle-containing layer is 100 mass % or less.

The first metal particles can be obtained by a known method or a method similar thereto. The first metal particles may be a commercially available product. The coating with a silver-containing coating layer on the core particles may performed by a plating method, a gas phase method (vapor deposition, sputtering, etc.), or the like.

In the first metal particle-containing layer, the mass ratio of Si to the metals such as Ag (=Si/metals (Ag, etc.)) may be 0.1 or more and 10 or less, 0.2 or more and 5.0 or less, or 0.2 or more and 3.0 or less. The mass ratio of Si to the metals is determined, with respect to the above cross section of the first metal particle-containing layer, using an electron probe microanalyzer (EPMA).

In the cross section of the first metal particle-containing layer, the ratio of the area occupied by the first metal particles to the total area occupied by the metal particles (=area of first metal particles/total area of metal particles) may be 0.20 or more and 1.00 or less (e.g., 0.50 or more and 1.00 or less), and may be 0.40 or more and 1.00 or less (e.g., 0.40 or more and 0.95 or less). This area ratio can be determined, using the aforementioned cross-sectional image, by energy dispersive X-ray spectroscopy (EDX).

### (Second Metal Particles)

Among the aforementioned second metal particles, silver particles are preferred. The silver particles may contain a small amount of impurities. The second metal particles may include silver particles and silver alloy particles. The silver particle content in the second metal particles is, for example, 80 mass % or more, and may be 90 mass % or more. The silver particle content in the second metal particles is 100 mass % or less. The second metal particles may be constituted only of silver particles.

The shape of the second metal particles is not particularly limited, and may be spherical (including oval spherical), flaky, indefinite, or other shapes. The second metal particles may include particles of one kind of shape, or may include a combination of particles of two or more kinds of shapes. For example, the second metal particles may include at least one selected from the group consisting of spherical particles and flaky particles. The second metal particles preferably include at least spherical particles. In this case, the second metal particles are easily dispersed in the paste, and the second metal particles can be easily highly packed in the second metal particle-containing layer. Furthermore, in the second metal particle-containing layer, a lot of contact points between particles can be ensured. Thus, higher conductivity of the second metal particle-containing layer can be ensured. This leads to a tendency that the effect of suppressing the initial ESR low is enhanced. The second metal particles may include, for example, spherical particles and particles having a shape other than spherical.

The average particle diameter of the second metal particles may be, for example, 0.01 μm or more and 50 μm or less, and may be 0.1 μm or more and 20 μm or less.

The aspect ratio and the degree of sphericity of the second metal particles may be selected from the ranges as described for the first metal particles. The aspect ratio, the degree of sphericity and the average particle diameter of the second metal particles are determined similarly to determining those of the first metal particles.

### (Third Metal Particles)

The third metal particles other than the first and second metal particles include, for example, metal particles substantially free of precious metals, such as silver and gold. Examples of such third metal particles include, for example, copper particles, copper alloy particles, nickel particles, and nickel alloy particles. Note that metal particles (excluding the first and second metal particles) containing precious metals as impurities are encompassed in the third metal particles.

When the first metal particle-containing layer contains the third metal particles, it is advantageous in terms of reducing the cost. However, as described above, the total proportion of copper particles and copper alloy particles is preferably low. It is also preferable when containing neither copper particles nor copper alloy particles. In addition, for ensuring higher conductivity, the proportion of the third metal particles in the whole metal particles contained in the first metal particle-containing layer is preferably low. The total proportion of the first metal particles and the second metal particles in the whole metal particles is, for example, 90 mass % or more, and may be 95 mass % or more. The total proportion of the first metal particles and the second metal particles in the whole metal particles is 100 mass % or less. The metal particles may be constituted only of the first metal particles, or only of the first and second metal particles.

### (Resin Binder)

Examples of the resin binder include thermoplastic resin materials and curable resin materials. The first metal particle-containing layer preferably contains a cured product of a resin binder (specifically, a cured product of a curable resin material) in that the deformation when exposed to high temperatures is relatively small.

The first metal particle-containing layer is formed, for example, using a conductive paste containing metal particles and a resin binder. For example, heating an applied film of the conductive paste can cure the resin binder, so that the first metal particle-containing layer is formed.

The curable resin material is exemplified by a resin composition containing a curable resin (e.g., thermosetting resin), a component involved in curing of a curable resin, and, as necessary, at least one selected from the group consisting of an additive and a liquid media. As the component involved in curing of a curable resin, for example, a polymerization initiator, a curing agent, a curing accelerator, a crosslinking agent, and a curing catalyst can be used depending on the kind of the curable resin. Such components may be used singly or in combination of two or more. As the additive, for example, a known additive used in a conductive paste for solid electrolytic capacitors can be used.

Preferred as the curable resin are an epoxy resin, a polyamide imide resin, a polyimide resin, a phenolic resin, and the like. The resin binder may contain these curable resins singly, or in combination of two or more.

In the first metal particle-containing layer, the amount of the resin binder or its cured product may be, for example, 2 parts by mass or more and 25 parts by mass or less, 5 parts by mass or more and 20 parts by mass or less, or 10 parts by mass or more and 20 parts by mass or less, relative to 100 parts by mass of the metal particles. It is not limited, however, to these ranges.

### (Others)

The metal particle content in the first metal particle-containing layer is determined, for example, in consideration of the balance between conductivity and adhesion. The metal particle content may be, for example, 80 mass % or more and 98 mass % or less, and may be 85 mass % or more and 96 mass % or less. The ratio of the metal particles, however, is not limited to these ranges. The metal particle content in the first metal particle-containing layer corresponds to the ratio (mass %) of the metal particles to the total dry solid content (total amount of components other than the liquid medium (i.e., solvent)) contained in the paste for forming a first metal particle-containing layer. Raw materials (monomers, etc.) of the cured product of a resin binder are not encompassed in the liquid medium.

The thickness of the first metal particle-containing layer is, for example, 0.5 μm or more and 100 μm or less, and may be 1 μm or more and 50 μm or less, and may be 1 μm or more and 20 μm or less.

The thickness of the first metal particle-containing layer is determined by measuring the thickness of the first metal particle-containing layer at a plurality of points (e.g., 10 points) in a SEM cross-sectional image and averaging the measured values.

For the measurement of the thickness of the first metal particle-containing layer, for example, a SEM cross-sectional image of a portion of the capacitor element that includes the first metal particle-containing layer is used. The cross-sectional image is prepared, for example, by the procedure similar to that for determining the degree of sphericity.

The first metal particle-containing layer can be formed by applying a conductive paste containing at least the first metal particles, the second metal particles, and a resin binder so as to cover at least part of at least one member (sometimes referred to as a component member) constituting the capacitor element (specifically, the cathode section), and performing a heat treatment. The component member to which the conductive paste is applied includes a layer in contact with the first metal particle-containing layer in the cathode section, such as a solid electrolyte layer, a cathode-leading layer, a first or a second layer constituting the cathode-leading layer, and a cathode lead.

The conductive paste can be obtained by mixing the constituent components. A known method can be used for mixing. The liquid medium used for preparation of the conductive paste is a medium which is liquid at the temperature at which the conductive paste is prepared or applied, and may be a medium which is liquid at room temperature (e.g., 20° C. to 35° C.). For example, an organic solvent is used as the liquid medium. An organic solvent and water may be used in combination as the liquid medium. The liquid medium is selected according to the type of curable resin, the component involved in curing, the additive, and the like.

### (Others)

The solid electrolytic capacitor may be of a wound type, a chip type, or a stacked type. When the solid electrolytic capacitor includes a plurality of capacitor elements, each capacitor element may be of a wound type or a stacked type. For example, a stacked solid electrolytic capacitor includes a plurality of stacked capacitor elements. The configuration of the capacitor element may be selected according to the type of the solid electrolytic capacitor.

In the capacitor element, to the cathode leading layer, one end of the cathode lead is electrically connected, for example. To the anode body (specifically, the anode leading part), one end of the anode lead is electrically connected, for example. The other end of the anode lead and the other end of the cathode lead are each drawn out from the package body. The other end of each lead exposed from the package body is used for solder connection with a substrate on which the solid electrolytic capacitor is to be mounted, and is electrically connected to an external electrode. At least part of the external electrode constitutes an external terminal of the solid electrolytic capacitor. As each of the leads, a lead wire may be used, or a lead frame may be used. Without limited to the case of using a lead wire, the end face of the anode leading part may be exposed from the package body and connected to an external electrode. A cathode foil may be connected to the cathode leading layer, and the end face of the cathode foil may be exposed from the package body and connected to an external electrode. The end face of the other end of the lead connected to the cathode leading layer may be exposed from the package body and connected to an external electrode.

The capacitor element is sealed, for example, with a package body. For example, the capacitor element and the resin material of the package body (e.g., uncured thermosetting resin and filler) may be placed in a mold, and the capacitor element may be sealed in the resin package body by transfer molding, compression molding, or other methods. At this time, a portion on the other end side of the anode lead and a portion on the other end side of the cathode lead, which are drawn out from the capacitor element, are exposed from the mold. Alternatively, the capacitor element may be housed in a bottomed case, such that the portion of the other end side of the anode lead and the portion on the other end side of the cathode lead are positioned on the opening side of the bottomed case. By sealing the opening of the bottomed case with a sealing body, a solid electrolytic capacitor can be formed.

FIGURE is a schematic sectional view showing the structure of a solid electrolytic capacitor according to one embodiment of the present disclosure. As shown in FIGURE, a solid electrolytic capacitor 1 includes a capacitor element 2, a resin package body 3 sealing the capacitor element 2, and an anode terminal 4 and a cathode terminal 5 each of which is at least partially exposed to outside the resin package body 3. The anode terminal 4 and the cathode terminal 5 can be constituted of a metal, such as copper and copper alloy. The resin package body 3 has an approximate rectangular parallelepiped outer shape, and the solid electrolytic capacitor 1 also has an approximate rectangular parallelepiped outer shape.

The capacitor element 2 includes an anode body 6, a dielectric layer 7 covering the anode body 6, and a cathode section 8 covering the dielectric layer 7. The cathode section 8 includes a solid electrolyte layer 9 covering the dielectric layer 7, and a cathode leading layer 10 covering the solid electrolyte layer 9. The cathode leading layer 10 includes a first layer 11 covering the solid electrolyte layer 9, and a second layer 12 covering the first layer.

The anode body 6 includes a region facing the cathode section 8 and a region not facing the cathode section 8. Of the region of the anode body 6 not facing the cathode section 8, on a portion adjacent to the cathode section 8, a separation part 13 with insulating properties is formed in a belt shape so as to cover the surface of the anode body 6, restricting the contact between the cathode section 8 and the anode body 6. Of the region of the anode body 6 not facing the cathode section 8, a portion of the rest is electrically connected to the anode terminal 4 by welding. The cathode terminal 5 is electrically connected to the cathode section 8 via a first conductive adhesive layer 14.

In the illustrated example, at least one of the second layer 12 and the first conductive adhesive layer 14 (preferably at least the second layer 12) may be a first metal particle-containing layer containing first metal particles. As described above, by including the first metal particle-containing layer in the cathode section, while suppressing the cost, it is possible to suppress the leakage current after the solid electrolytic capacitor is exposed to high temperatures. In addition, since the first metal particles ensure high conductivity of the first metal particle-containing layer, the initial ESR can be suppressed low.

### EXAMPLES

The present invention will be specifically described below with reference to Examples and Reference Examples. The present invention, however, is not limited only to the following Examples.

### Examples 1 to 3 and Comparative Example 1

Capacitor elements or solid electrolytic capacitors were produced and evaluated in the following manner.

### (1) Preparation of Anode Body

An aluminum foil (thickness: 100 μm) serving as a base material was roughened on both surfaces by etching, into an anode body.

### (2) Formation of Dielectric Layer

The anode body was immersed at a portion on the other end side in a chemical conversion solution, and a direct current voltage of 2.5 V was applied thereto for 20 minutes to form a dielectric layer containing aluminum oxide.

### (3) Formation of Solid Electrolyte Layer

An aqueous solution containing pyrrole monomer and p-toluenesulfonic acid was prepared. The monomer concentration in the aqueous solution was 0.5 mol/L, and the concentration of p-toluenesulfonic acid was 0.3 mol/L.

The anode body including the dielectric layer formed in the above (2) and a counter electrode were immersed in the resultant aqueous solution, in which electrolytic polymerization was allowed to proceed at 25° C. at a polymerization voltage of 3 V (polymerization potential relative to a silver reference electrode), to form a solid electrolyte layer.

### (4) Formation of Cathode Section

The anode body obtained in the above (3) was immersed in a dispersion liquid of graphite particles in water, and after taken out from the dispersion liquid, dried, to form a first layer (carbon layer) at least on the surface of the solid electrolyte layer. Drying was performed at 150° C. for 30 minutes.

Next, a conductive paste containing metal particles shown in Tables was applied onto a surface of the first layer, and a heat treatment was performed at 210° C. for 10 minutes, to form a second layer which was a metal particle-containing layer. In this way, a cathode leading layer constituted of a first layer and a second layer was formed. The thickness of the second layer was about 10 μm. A capacitor element was thus produced.

The conductive paste used for forming a second layer was prepared by mixing metal particles shown in Tables, a resin binder, and a liquid medium (or a dispersion liquid or solution containing a resin binder). The resin binder used here was an epoxy resin composition. The ratio of metal particles to the total amount of components other than the liquid medium in the conductive paste (total dry solid content) was 87.5 mass %. The ratio of the resin binder relative to 100 parts by mass of the total amount of metal particles was 14 parts by mass. The metal particles in Tables were metal particles described below. For each Example, the density of the conductive paste was calculated from the composition of the conductive paste.
(a) First metal particles: silver-coating particles each including a core particle made of fused silica and a silver coating layer covering the core particle (silver coverage approx. 20 mass %, average particle diameter 4.1 μm, spherical (degree of sphericity: 0.9), aspect ratio of core particle: approx. 1, degree of sphericity of core particle: 0.9)
(b) Second metal particles: silver particles (aspect ratio: approx. 3, spherical (degree of sphericity: 0.6), average particle diameter 2.0 μm)
(c) Third metal particles: copper particles (average particle diameter: approx. 2 μm, degree of sphericity: 0.4)

The degree of sphericity of each particle corresponds to the degree of sphericity obtained from a cross-sectional image of the metal particle-containing layer by the already-described procedure.

### (5) Fabrication of Solid Electrolytic Capacitor

With respect to Example 1 and Comparative Example 1, a solid electrolytic capacitor was fabricated using the capacitor element obtained in the above (4) by the following procedure.

The cathode leading layer of the capacitor element was joined to one end of a cathode lead using a conductive adhesive. A portion of the anode body covered with neither the solid electrolyte layer nor the cathode leading layer was bonded at its one end to one end of an anode lead by laser welding. A resin package body made of an insulating resin was then formed around the capacitor element by molding. At this time, the other end of the anode lead and the other end of the cathode lead were drawn out from the resin package body. In this way, a solid electrolytic capacitor was completed.

With respect to the capacitor elements of Examples 1 to 3, the mass ratio of silica to silver (metal) in the cross section of the first metal particle-containing layer was determined according to the already-described procedure, which was within the range of approximately 0.2 or more and 3.0 or less. Furthermore, in the cross section of the first metal particle-containing layer, the area ratio of the first metal particles to the whole metal particles was within the range of approximately 0.50 or more and 1.00 or less.

### [Evaluation]

The solid electrolytic capacitors or the capacitor elements were subjected to the following evaluations.

### (a) Leakage Current (LC) of Solid Electrolytic Capacitor

With respect to the solid electrolytic capacitors of Example 1 and Comparative Example 1, the leakage current (LC) was evaluated by the following procedure.

At 25° C., a resistance of 1 kΩ was connected in series to each solid electrolytic capacitor, and the leakage current (uA) was measured after applying a rated voltage of 2 V from a DC power source for 1 minute. An average value (initial leakage current (initial LC)) of 30 solid electrolytic capacitors was determined.

Next, the solid electrolytic capacitors were left to stand at 185° C. for 4 hours, and then left to stand in a humidified environment of 85% RH at 85° C. for 12 hours. Next, the solid electrolytic capacitors were left to stand again at 185° C. for 4 hours, and then left to stand in a humidified environment of 85% RH at 85° C. for 12 hours. Thereafter, the solid electrolytic capacitors were heated at 295° C. for 6 minutes, simulating a reflow process. The leakage current after this heating (reflow) was measured in the same manner as measuring the initial leakage current, and an average value (leakage current after reflow (LC after reflow)) of the 30 solid electrolytic capacitors was obtained.

### (b) Short-Circuit Defect Rate of Solid Electrolytic Capacitor

In the measurement of leakage current after reflow in the above (a), the ratio (%) of the number of solid electrolytic capacitors in which a leakage current exceeding 1 mA was measured to the 30 capacitors was calculated. This ratio was determined as a short-circuit defect rate.

### (c) ESR

With respect to the capacitor elements obtained in Examples 1 to 3 and Comparative Example 1, in a 25° C. environment, the initial ESR (mΩ) of each capacitor element was measured at a frequency of 100 kHz using a four-terminal LCR meter. With respect to the initial ESR, an average value of 40 capacitor elements was calculated.

The capacitor elements were randomly divided into two groups, each consisting of 40 elements. The capacitor elements in one group were subjected to a heat resistance test in which they were left to stand at 145° C. for 450 hours. With respect to the capacitor elements after heat resistance test, the ESR was measured in the same manner as measuring the initial ESR, and an average value for the 40 capacitor elements (ESR after heat resistance test) was calculated.

The capacitor elements in the other group were subjected to a humidity test in which they were left to stand in a humid environment of 85% RH at 85° C. for 450 hours. With respect to the capacitor elements after humidity resistance test, the ESR was measured in the same manner as measuring the initial ESR, and an average value (ESR after the humidity resistance test) of the 40 capacitor elements was calculated.

The evaluation results of the solid electrolytic capacitor are shown in Table 1, and the evaluation results of the capacitor element are shown in Table 2. In Tables, E1 to E3 are of Examples 1 to 3, respectively, and C1 is of Comparative Example 1. Note that the ESR values after heat resistance test and moisture resistance test, and the density of the conductive paste of C1 in Table 2 are estimated values through simulation.

TABLE 1

| | | initial LC | LC after reflow | short-circuit |
|---|---|---|---|---|
| | metal particles | (μA) | (μA) | defect rate |
| E1 | fist metal particles | 1.80 | 2.10 | 0.0 |
| C1 | copper particles | 2.50 | 82.11 | 36.7 |

As shown in Table 1, the initial LC of the solid electrolytic capacitor was not much different between E1 in which the first metal particles were used in the cathode section, and C1 in which copper particles were used. In E1, even after the solid electrolytic capacitor was exposed to a high temperature and high humidity environment and then heated to simulate a reflow process, the leakage current (LC after reflow) was almost the same as the initial LC, which was suppressed low. Furthermore, in E1, the ratio of the solid electrolytic capacitors that exhibited a large leakage current exceeding 1 mA (LC defect rate) was 0%. In contrast to these results of E1, in C1, the LC after reflow was about 40 times as large as that of E1, and the LC defect rate was also as high as 36.7%.

The reason why the LC after reflow was high in C1 is presumably for the following reasons. In C1, it is considered that part of the copper particles are ionized and migrate to the solid electrolyte layer when heated in a high temperature environment or during the reflow process, and the copper component reaches the insulating dielectric layer. The copper component that has migrated to the dielectric layer causes a current to flow between the anode body and the cathode section, which increases the leakage current.

Furthermore, in the first metal particles used in E1, in which the core particles are covered with a silver-containing coating layer, the migration of the constituent ions of the first metal particles in a high temperature environment or during the above heating is suppressed. Furthermore, when the first metal particles are used, the silver coating layer can ensure high conductivity that is comparable to that when silver particles or silver alloy particles are used. In addition, the first metal particles, because of the core particle being silica, have a smaller specific gravity than silver particles, silver alloy particles, copper particles, etc. Therefore, the cost per unit volume can be reduced, and the solid electrolyte layer can be covered with a small mass of paste. Thus, by using the first metal particles, it is possible to reduce the cost, and reduce the leakage current after exposure to high temperatures, leading to high reliability.

TABLE 2

| | | | | | | ESR after | density of |
|---|---|---|---|---|---|---|---|
| | metal particles (mass %) | | | initial | ESR after heat | moisture | conductive |
| | first metal | silver | copper | ESR | resistance test | resistance test | paste |
| | particles | particles | particles | (mΩ) | (mΩ) | (mΩ) | (g/cm³) |
| E1 | 100 | 0 | 0 | 27 | 72 | 70 | 1.6 |
| E2 | 39 | 61 | 0 | 19 | 31 | 52 | 2.3 |
| E3 | 29 | 71 | 0 | 16 | 37 | 48 | 2.6 |
| C1 | 0 | 0 | 100 | 134 | 342 | 304 | 3.1 |

As shown in Table 2, in E1, as compared to C1, the initial ESR of the capacitor element was significantly low. In the first metal particles as used in E1, the silver coating layer included therein can ensure high conductivity, enabling to ensure high conductivity of the metal particle-containing layer. Therefore, the initial ESR of the capacitor element can be suppressed low. In the case of using the first metal particles in combination with the second metal particles (silver particles, etc.), the specific gravity of the metal particles as a whole can be suppressed low to a certain extent, and the initial ESR can be further suppressed low because of the high conductivity of the second metal particles (comparison of E1 with E2 and E3). Furthermore, in E1 to E3, in which the first metal particles (and second metal particles) were used, the oxidation deterioration of the metal particles was suppressed even in the heat resistance test and the moisture resistance test, resulting in low ESRs after heat resistance test or moisture resistance test of the capacitor element. This leads to high reliability.

In E2 and E3, in which the first metal particles were used in combination with silver particles as the second metal particles, the migration of the metal components constituting the metal particles as occurring in the case of C1 using copper particles was suppressed. Therefore, in E2 and E3, too, the leakage current suppression effect equivalent to or superior to that in E1 of Table 1 can be obtained.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

According to the solid electrolytic capacitor of the present disclosure, while suppressing the cost, it is possible to suppress low the leakage current after exposure to high temperatures. It is also possible to suppress low the leakage current after reflow processing. Furthermore, in the solid electrolytic capacitor of the present disclosure, the initial ESR is low, and the fluctuations in ESR can be suppressed even after exposure to a high temperature environment or a high temperature and high humidity environment. Therefore, according to the present disclosure, a solid electrolytic capacitor with high reliability can be provided at inexpensive prices. Thus, the solid electrolytic capacitor can be applied to various applications and is also suitable for applications requiring high reliability. It is to be noted, however, that these are merely examples, and the applications of the solid electrolytic capacitor are not limited to these examples only.

### REFERENCE NUMERALS

1: solid electrolytic capacitor
2: capacitor element
3: package body (resin package body)
4: anode lead (anode terminal)
5: cathode lead (cathode terminal)
6: anode body
7: dielectric layer
8: cathode section
9: solid electrolyte layer
10: cathode-leading layer
11: first layer
12: second layer
13: separation part
14: first conductive adhesive layer

What is claimed is:

1. A solid electrolytic capacitor element, comprising
an anode body, a dielectric layer formed at a surface of the anode body, and a cathode section covering at least part of the dielectric layer, wherein
the cathode section includes a solid electrolyte layer covering at least part of the dielectric layer, and includes a metal particle-containing layer in at least part of the cathode section,
the solid electrolyte layer contains a conductive polymer,
metal particles contained in the metal particle-containing layer include first metal particles containing silver, and
the first metal particles each include a core particle containing silica, and a silver-containing coating layer covering the core particle.

2. The solid electrolytic capacitor element according to claim 1, wherein a proportion of the first metal particles in the whole metal particles is 10 mass % or more.

3. The solid electrolytic capacitor element according to claim 1, wherein an average of aspect ratios of the core particles is 1 or more and 10 or less.

4. The solid electrolytic capacitor element according to claim 1, wherein an average of proportions of the silver-containing coating layers in the first metal particles is 0.1 mass % or more and 50 mass % or less.

5. The solid electrolytic capacitor element according to claim 1, wherein
the metal particles include second metal particles containing silver, and
each of the second metal particles is at least one selected from the group consisting of silver particles and silver alloy particles.

6. A solid electrolytic capacitor, comprising at least one solid electrolytic capacitor element according to claim 1, and a package body sealing the solid electrolytic capacitor element.

7. The solid electrolytic capacitor according to claim 6, including a plurality of the solid electrolytic capacitor elements stacked together.
